(19) United States
(12) Patent Application Publication
(10) Pub. No.: US 2012/0211091 A1
(43) Pub. Date: Aug. 23, 2012

(54) IN-LINE FLUSH VALVE

(76) Inventors: Alex Carter, Miami, FL (US); Keith Carter, Sharpsburg, GA (US)

(21) Appl. No.: 13/399,191

(22) Filed: Feb. 17, 2012

Related U.S. Application Data
(60) Provisional application No. 61/445,332, filed on Feb. 22, 2011.

(51) Int. Cl. B08B 3/00

(52) U.S. Cl. 137/15.04; 137/605

(57) ABSTRACT

An in-line flush valve, comprising a t-shaped hollow body having a central flow passageway, at least three spaced-apart hollow ends in flow communication with the central flow passageway, wherein a first hollow end and a second hollow end share a common radial axis, are disposed in opposing relation, and define a pass-through conduit, wherein a radial axis of a third hollow end is substantially perpendicular with respect to the common axis of the first hollow end and the second hollow end, wherein the pass-through conduit is disposed between and in flow communication with an inlet of a pump and a fluid source, and wherein the third hollow end is adapted to receive fluid to flush said pump.

### CLAIM OF PRIORITY

This application is being filed as a non-provisional patent application under 35 U.S.C. §111(b) and 37 CFR §1.53(c). This application claims priority under 35 U.S.C. §111(e) to U.S. provisional patent applications Ser. No. 61/445,332 filed on Feb. 22, 2011, the contents of which are incorporated herein by reference.

### FIELD OF INVENTION

The present invention relates generally to flushing systems for fluid pumps and more specifically to an in-line flush valve for flushing and/or cleaning a fluid pump. The present invention is widely applicable but is particularly useful in marine applications, where seawater causes excessive corrosion in fluid pumps.

### BACKGROUND OF THE INVENTION

Nearly all recreational and commercial boats incorporate one or more fluid pumps for a variety of useful purposes such as filling bait wells and running wash-down hoses. It is quite common to have on board one or more pumps which receive water from the ocean, river, lake, pond, etc., in which the boat is disposed. Typically, such pumps are electric, running off the vessel's battery or generator.

In the most basic embodiment, these pumps have a single input which receives source water through a pipe or tubing attached to a seacock, wherein the seacock is a specialized valve on the hull of the boat. Accordingly, source water is brought into the boat through the seacock, is pulled through to the pump, and then exits the pump to any number of locations within the boat's plumbing, such as for example, the aforementioned bait well and/or wash-down hose.

For many saltwater faring vessels in particular, corrosion is a primary concern. If vessel components that are exposed to saltwater are not cleaned or flushed soon after exposure, corrosion and oxidation can set in rapidly. Of particular concern are a vessel's saltwater pumps, which are constantly exposed to the corrosive characteristics of salty sea water. If left un-flushed, components within the pump will corrode over time, resulting in malfunction and/or failure of the pump.

Such malfunctions and failures can necessitate expensive repair and/or costly replacement. The act of flushing such components, however, can represent a major inconvenience or may not be possible at all without significant teardown to gain access to the components. Therefore, said components often go un-flushed.

Accordingly, there exists a need in the art for a simple-to-operate, effective, and inexpensive device useful for flushing on-board water pumps with fresh water, to eliminate long-term exposure to saltwater (or other corrosive water, such as brackish water or polluted freshwater) and thus reduce or prevent corrosion within the pump.

### SUMMARY OF THE INVENTION

The disclosed invention consist of an in-line flush valve, comprising a t-shaped hollow body having a central flow passageway, at least three spaced-apart hollow ends in flow communication with the central flow passageway, wherein a first hollow end and a second hollow end share a common radial axis, are disposed in opposing relation, and define a pass-through conduit, wherein a radial axis of a third hollow end is substantially perpendicular with respect to the common axis of the first hollow end and the second hollow end, wherein the pass-through conduit is disposed between and in flow communication with an inlet of a pump and a fluid source, and wherein the third hollow end is adapted to receive fluid to flush said pump.

An alternative embodiment of the disclosed invention consists of an in-line flush valve, comprising a generally tubular body having an input end and an output end, a t-fitting comprised of a hollow body having a central flow passageway and at least three spaced-apart hollow ends in flow communication with the central flow passageway, wherein a first hollow end and a second hollow end of the t-fitting share a common radial axis, are disposed in opposing relation, and define a pass-through conduit, wherein a radial axis of a third hollow end of the t-fitting is substantially perpendicular with respect to the common axis of the first hollow end and the second hollow end, wherein the output end of the tubular body is in flow communication with the third hollow end of the t-fitting, wherein the pass-through conduit is disposed between and in flow communication with an inlet of a pump and a fluid source, wherein the input end of the tubular body is adapted to receive fluid, and wherein the fluid flows through the tubular body to the t-fitting, to flush the pump.

A second alternative embodiment of the disclosed invention consists of A method for flushing a pump, comprising the steps of: (a) installing a flush valve between the pump and a fluid source, the flush valve comprising a t-shaped hollow body having a central flow passageway, at least three spaced-apart hollow ends in flow communication with the central flow passageway, wherein a first hollow end and a second hollow end share a common radial axis, are disposed in opposing relation, and define a pass-through conduit permitting fluid flow between the fluid source and the pump, and wherein a radial axis of a third hollow end is substantially perpendicular with respect to the common axis of the first hollow end and the second hollow end; (b) connecting a hose to the third hollow end; (c) operating a valve on the flush valve to the open position, the valve disposed between the third hollow end and the pass-through conduit; (d) running flush water from the hose through the flush valve and into the pump over the pass-through conduit; (e) operating the valve on the flush valve to the closed position; and (f) disconnecting the hose from the third hollow end.

### BRIEF DESCRIPTION OF THE DRAWINGS

FIG. 1 is a front view of one embodiment of the present invention.

FIG. 2 is a schematic of one embodiment of the present invention configured to flush a single pump.

FIG. 3 is a schematic of one embodiment of the present invention configured to flush two pumps.

FIG. 4 is a front view of another embodiment of the present invention.

FIG. 5 is a schematic of the embodiment in FIG. 4 configured to flush a single pump.

### DETAILED DESCRIPTION OF THE INVENTION

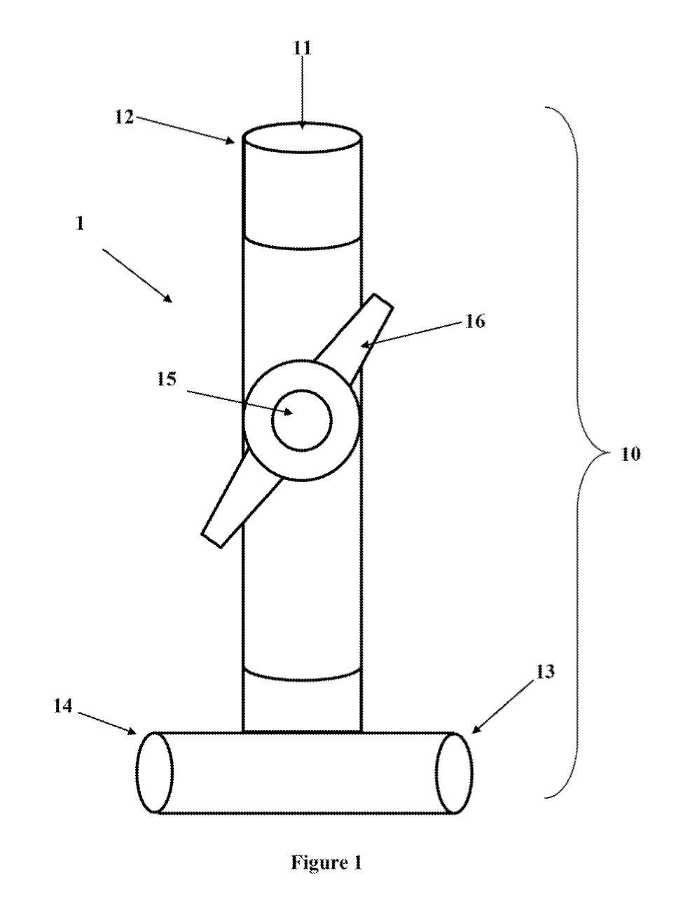

With reference to FIG. 1, shown is one embodiment of the in-line flush valve of the present invention. As shown, in-line flush valve 1 comprises a generally t-shaped hollow body 10 having a central flow passageway (where 11 points) and three spaced-apart hollow ends, flush input 12, inlet 13, and outlet 14, each in flow communication with the central flow passageway. As shown, in some embodiments, inlet 13 and outlet 14 share a common axis and are disposed in opposing relation. In some embodiments, the axis of flush input 12 is substantially perpendicular with respect to the common axis of inlet 13 and outlet 14.

Along body 10 and disposed between flush input 12 and inlet 13/outlet 14 is a valve 15 which is adapted to open and close the central flow passageway. Accordingly, valve control knob 16 can be manipulated as desired, typically by rotating it, in order to control the flow of fluid received from flush input 12. In some embodiments, valve 15 is a ball valve as is known in the art; however other valve configurations known in the art may be employed, such as a butterfly valve, plug valve, or the like.

In accordance with the foregoing, in-line flush valve 1 is intended to be inserted between the inlet of a pump and the fluid source of the pump (i.e., downstream from the inlet of a pump), in order to flush the pump with fresh water received by flush inlet 12. Accordingly, in a typical operating mode, inlet 13 and outlet 14 define a pass-through conduit for the source fluid that is moved by the pump. Thus, when valve 15 is closed, the pump functions normally, pulling source fluid from the source, into inlet 13, across outlet 14 and into the pump. When flushing is desired, a fresh water source is connected to flush input 12 and valve 15 is opened, thus sending fresh water through the pump, which removes any unwanted contaminated water that would otherwise remain within the pump.

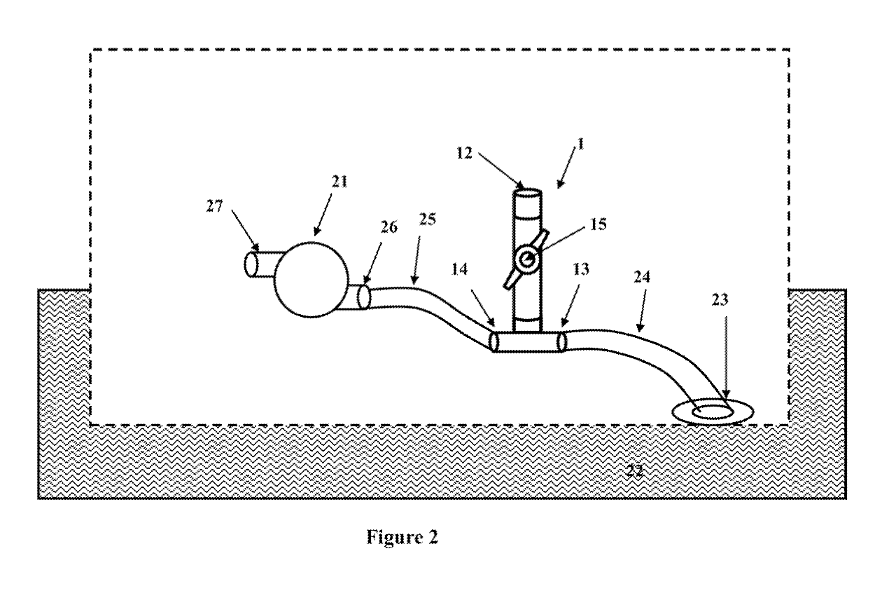

The following provides several non-limiting examples of useful configurations of the in-line flush valve 1 of the present invention. With reference to FIG. 2, in some embodiments, in-line flush valve 1 is disposed between pump 21 and fluid source 22. As noted above, fluid source 22 is typically an ocean, lake, river, pond, etc., wherein pump 21 is adapted to move fluid from the fluid source 22 to a desired destination. Accordingly, with pump 21 operating normally and valve 15 closed, source fluid is received by seacock 23, which is attached to the hull of vessel, and brought on board through inlet tube 24. Inlet 13 is attached to inlet tube 24, thus placing inlet 13 downstream of fluid source 22 such that fluid flows across device 1, from inlet 13 out outlet 14, then flowing though outlet tube 25, and continuing on to input 26 of pump 21. At that point, fluid exits pump 21 though output 27, and continues on to any number of destinations, such as a bait well or wash-down hose.

When pump 21 needs to be flushed, a fresh water source is attached to flush input 12 of in-line flush valve 1. Valve 15 is then opened, allowing fresh water to flow through in-line flush valve 1 and out outlet 14, through input 26 and into pump 21, thus flushing any contaminants in pump 21. In some embodiments, it is desirable to turn pump 21 off during flushing, in order to prevent excess source water from entering the pump. To that end, seacock 23 may also be closed. Further, in some embodiments, a check valve may be placed at inlet 13 or between inlet 13 and outlet 14 such that fluid, whether source fluid or fresh water, can only flow in one direction, namely toward pump 21. This ensures that, during flushing, the fresh water can only flow toward pump 21 and does not flow out from inlet 13 toward seacock 23. Further, a check valve may be located at flush input 12 such that, in the event that valve 15 is left open while the pump is in operation, source fluid will not flow out of flush input 12. In some embodiments, during flushing, fresh water is pulled through pump 21, exiting outlet 27, at which point it may be expelled from the system. For example, if pump 21 is attached to a wash-down hose located upstream therefrom, fresh water flowing through the pump during the flushing process may be expelled by activating the wash-down hose. In this case, pump 21 may be in operation during flushing.

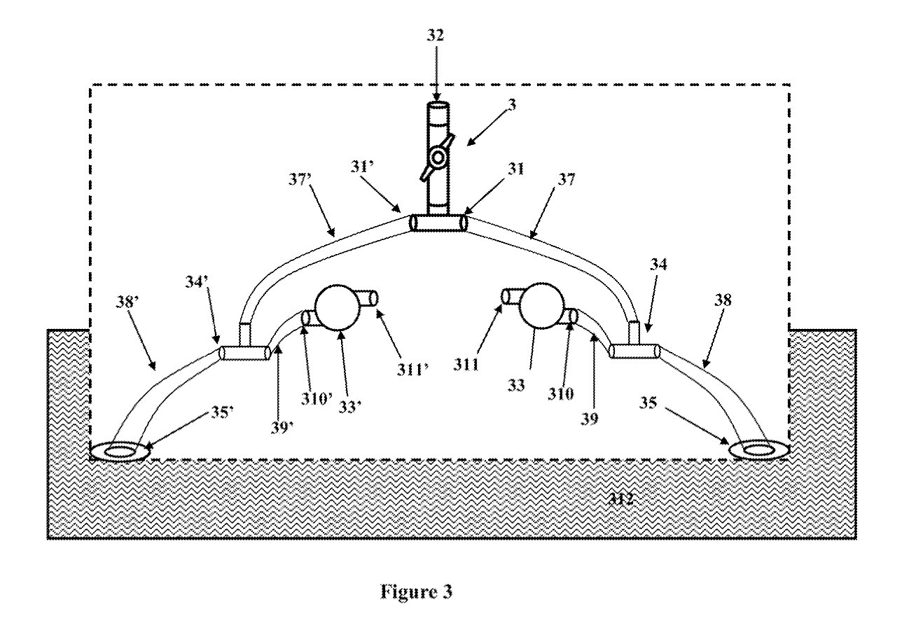

In another embodiment, the present invention can be used to flush a plurality of pumps, rather than just a single pump. With reference to FIG. 3, shown is in-line flush valve 3 connected to two discrete pump arrangements. In this configuration, in-line flush valve 3 has a flush input 32 and two outputs 31 and 31′. Outputs 31 and 31′ are each connected to t-fittings 34 and 34′, respectively, wherein t-fittings 34 and 34′ receive source fluid from seacocks 35 and 35′, respectively, by way of tubes 38 and 38′, respectively, and pass the source fluid to inputs 310 and 310′ of pumps 33 and 33′ over tubes 39 and 39′, respectively. With in-line flush valve 3 closed, pumps 33 and 33′ operate normally, pull water from the source 312 and send it to any desired destination over pump outputs 311 and 311′ respectively. When flushing is desired, a fresh water source is attached to flush input 32, in-line flush valve 3 opened, sending fresh water though outputs 31 and 31′ into the plumbing system over tubes 37 and 37′, through t-fittings 34 and 34′ and lastly into pumps 33 and 33′. In accordance with the foregoing, it is understood that in-line flush valve 3 is capable of integrating into a module, scalable plumbing and/or pump system which permits a plurality of pumps, and their attendant plumbing, to be flushed with fresh water.

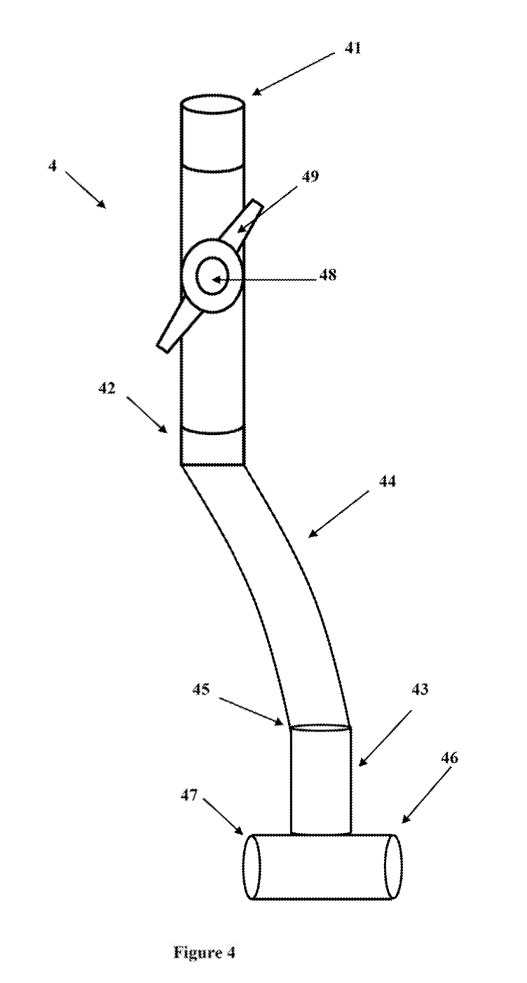

FIG. 4 is another embodiment of the in-line flush valve of the present invention, configured for a “remote” installation. This configuration permits the flush input 41 of in-line flush valve 4 to be installed at a location that is remote from the pump plumbing and easily accessible by a user. Shown is in-line flush valve 4 which is generally a tube having a hollow body and two hollow ends, flush input 41 and flush output 42. Flush output 42 is connected to t-fitting 43 by tube 44. T-fitting 43 has a hollow body and three hollow ends, input 45, inlet 46, and outlet 47. In-line flush valve 4 has a valve 48 which is controlled by knob 49. In this configuration, the length and geometry of tube 44 can be altered as desired, depending on the distance between the pump plumbing and the desired remote flush input 41 location. It is further understood that tube 44 can be comprised of a flexible material such that it may be installed to avoid any obstructions or other structures that may exist between the in-line flush valve 4 and t-fitting 43.

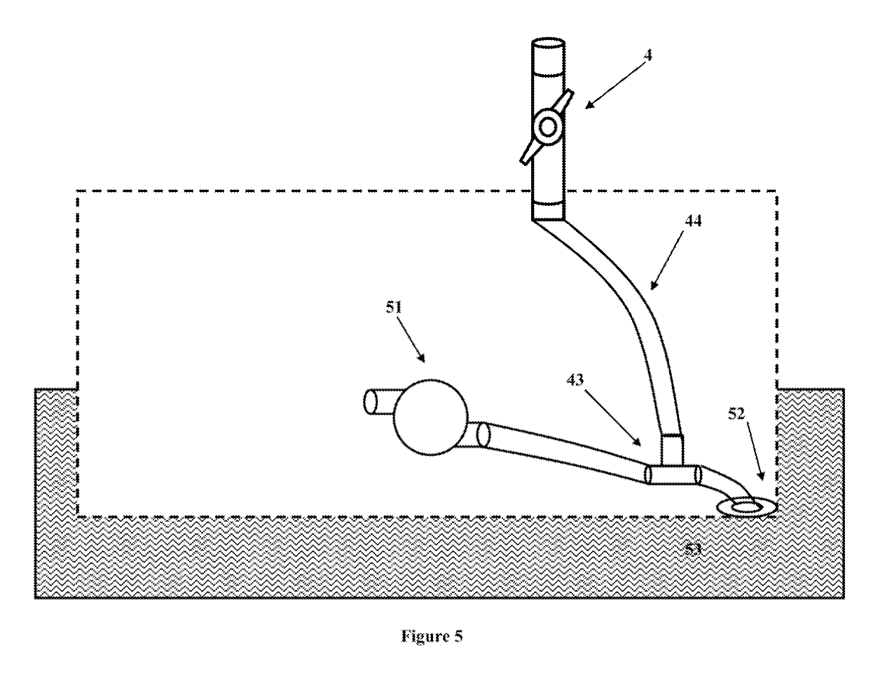

In accordance with the embodiment shown in FIG. 4, t-fitting 43 is intended to be inserted between the inlet of a pump and the fluid source of the pump (i.e., downstream from the inlet of a pump), in order to receive fresh water from in-line flush valve 4. Accordingly, in a typical operating mode, inlet 46 and outlet 47 function as a pass-through conduit for the source fluid that is moved by the pump. Thus, when valve 48 is closed, the pump functions normally, pulling source fluid from the source, into inlet 46, across outlet 47 and into the pump. When flushing is desired, a fresh water source is connected to flush input 41 and valve 48 is opened, thus sending fresh water through the in-line flush valve 4, through tube 44, into t-fitting 43 and into the pump over outlet 47, which removes any unwanted contaminated water that would otherwise remain within the pump. FIG. 5 depicts one example of in-line flush valve 4 in a remote configuration, assembled with t-fitting 43, tube 44, pump 51, seacock 52, and source 53.

In accordance with the foregoing, it is understood that the in-line flush valve of the present invention is adapted to be used in a variety of plumbing systems and arrangements, provided that the in-line flush valve is located downstream of the pump's inlet such that fresh water can be introduced into the pump for flushing purposes. In this fashion, other components of the plumbing system can also be flushed, in that, in most cases, the pump is located at the “front” of the plumbing system. Furthermore, the in-line flush valve of the present invention is not limited only to marine applications or even saltwater applications. Indeed, the present invention is useful in a wide variety of applications where it is desirable to flush any type of pump and/or pump plumbing system that may contain contaminants.

It is further understood that the various components, fittings, and hollow ends of the present invention can be adapted to be compatible with a wide variety fitting connectors and configurations. For example, it may be useful for the flush input of the in-line flush valve to have a threaded connector that is compatible with a standard garden hose (i.e. ¾″ or ⅝″) or any other like connector known in the art. Accordingly, fresh water may be introduced at the flush input from a hose that is connected to a fresh water source. Such a fresh water source could be a tank on a vessel or could be a spigot, faucet, or other like source on dry land.

Further still, the flush input may have a “quick-release” connection as is known in the art, wherein a fresh water source hose has a male connector which is adapted to snap-fit into a female connector at the flush input of the in-line flush valve. In some embodiments, the female connector contains a check valve that prevents the flow of fluid unless and until the male connector is engaged therewith. These “quick-release” connectors can be utilized at any of the fitting points, for example, at the inlet and outlet of the in-line flush valve, if desired. Further still, the fittings and hollow ends of the in-line flush valve can be adapted to receive any number of various hose barbs known in the art, which are useful for mating the fittings and/or hollow ends to hoses, tubes, or other connectors that do not have the same dimensions and/or thread configuration.

Additionally, the in-line flush valve of the present invention may be adapted such that its body can receive and/or be attached to a wide variety of known brackets and mounting structures.

In the foregoing description, the present invention has been described with reference to specific exemplary embodiments thereof. It will be apparent to those skilled in the art that a person understanding this invention may conceive of changes or other embodiments or variations, which utilize the principles of this invention without departing from the broader spirit and scope of the invention. The specification and drawings are, therefore, to be regarded in an illustrative rather than a restrictive sense.

We claim:

1. An in-line flush valve, comprising:
a t-shaped hollow body having a central flow passageway;
at least three spaced-apart hollow ends in flow communication with said central flow passageway;
wherein a first hollow end and a second hollow end share a common radial axis, are disposed in opposing relation, and define a pass-through conduit;
wherein a radial axis of a third hollow end is substantially perpendicular with respect to said common axis of said first hollow end and said second hollow end;
wherein said pass-through conduit is disposed between and in flow communication with an inlet of a pump and a fluid source;
wherein said third hollow end is adapted to receive fluid to flush said pump.

2. An in-line flush valve, comprising:
a generally tubular body having an input end and an output end;
a t-fitting comprised of a hollow body having a central flow passageway and at least three spaced-apart hollow ends in flow communication with said central flow passageway;
wherein a first hollow end and a second hollow end of said t-fitting share a common radial axis, are disposed in opposing relation, and define a pass-through conduit;
wherein a radial axis of a third hollow end of said t-fitting is substantially perpendicular with respect to said common axis of said first hollow end and said second hollow end;
wherein said output end of said tubular body is in flow communication with said third hollow end of said t-fitting;
wherein said pass-through conduit is disposed between and in flow communication with an inlet of a pump and a fluid source;
wherein said input end of said tubular body is adapted to receive fluid, wherein said fluid flows through said tubular body to said t-fitting, to flush said pump.

3. A method for flushing a pump, comprising:
a. installing a flush valve between said pump and a fluid source, said flush valve comprising:
a t-shaped hollow body having a central flow passageway;
at least three spaced-apart hollow ends in flow communication with said central flow passageway;
wherein a first hollow end and a second hollow end share a common radial axis, are disposed in opposing relation, and define a pass-through conduit permitting fluid flow between said fluid source and said pump;
wherein a radial axis of a third hollow end is substantially perpendicular with respect to said common axis of said first hollow end and said second hollow end;
b. connecting a hose to said third hollow end;
c. operating a valve on said flush valve to the open position, said valve disposed between said third hollow end and said pass-through conduit;
d. running flush water from said hose through said flush valve and into said pump over said pass-through conduit;
e. operating said valve on said flush valve to the closed position;
f. disconnecting said hose from said third hollow end.
